(19) United States
(12) Patent Application Publication
(10) Pub. No.: US 2023/0330778 A1
(43) Pub. Date: Oct. 19, 2023

(54) PLANT AND METHOD FOR LASER SCORING

(71) Applicant: COMEXI GROUP INDUSTRIES, SAU, Riudellote De La Selva (ES)

(72) Inventors: Jordi Prat Gil, Girona (ES); Robert Mató Reverter, Caldes de Malavella (ES)

(73) Assignee: COMEXI GROUP INDUSTRIES, SAU, Riudellots De La Selva (ES)

(21) Appl. No.: 18/135,903

(22) Filed: Apr. 18, 2023

(30) Foreign Application Priority Data
Apr. 19, 2022 (EP) 22382365

(51) Int. Cl. B65H 35/00; B23K 26/364; B23K 26/082

(52) U.S. Cl. CPC B23K 26/364; B23K 26/082; B65H 35/0006; B65H 2301/4148; B65H 2301/5111; B65H 2301/51536; B65H 2301/5163

(57) ABSTRACT

Plant for laser scoring and laminating or vice versa a resealable label on a web material with option to dispense with lamination. The plant comprises:
an unwinder station (A) from which a web (11) is fed to a support and guiding
a laser station (B1) included in a guided passage of the above-mentioned web (11);
a labelling station (B2) included in another guided passage of the above-mentioned web (11), and
a slitter-rewinder station (C) to rewind and or slit the web (11) after treatment in the laser station (B1) and in the labelling station (B2),
wherein the web (11) of flexible material is selectively driven to pass firstly through the laser station (B1) and then through the labelling station (B2) or the other way around, or to pass only through the laser station (B1).

A method that implements the facility is proposed.

### TECHNICAL FIELD

The present invention relates to the field of packaging material including a resealable label or flap obtained from a web of flexible material which is treated in a plant defining a weakening zone by laser or similar and then apply by lamination a label with the possibility of change at will the order of the operations depending on the type of web material to be used or also allowing to perform only one laser treatment and in all cases including a final stage of cutting of several parallel strips of the material web and rewinding of each of the strips.

The invention proposes both a method and a plant to implement the technical concept.

### STATE OF THE ART

EP2881212B1 of the same applicant relates to a machine for perforating a film web, particularly a machine for perforating a continuous and moving film web intended for the formation of containers, for example for containing food products.

EP3170611 B1 of the same applicant discloses a continuous web laser treatment module, including a web material entrance and a web material exit connected through a web path, being a continuous web material transported along said web path, and said module including laser generators which create laser beams over said web material to burn it, cut it, print it, or to produce any other laser treatment on said web material continuously transported.

JP6041556B2 discloses an in-mould label forming apparatus for forming an in-mould label for moulding by a label forming means by sequentially transporting, to a label formation region in association with a winding operation, a label sheet derived from a sheet roll on which a plurality of label patterns are printed and wound at required intervals in a row direction that is a direction orthogonal to the transport direction.

JP6198265B2 divulges a material supporting shaft rotatably and axially supported on an upper side in a transport direction of a continuous sheet to which a surface base material sheet having a label graphic printed thereon is releasably adhered, the original material supporting shaft having a continuous sheet wound thereon being mounted thereon; A rotary roller and a pressure roller that sandwich a continuous sheet fed out from an original material roll, an electric motor that is connected to the rotary roller and transports the sandwiched continuous sheet in cooperation with the pressure roller, A continuous sheet feeding means connected to an original material supporting shaft, the continuous sheet feeding means including a braking mechanism that applies a predetermined braking force to the original material supporting shaft to apply a predetermined tension to the continuous sheet fed from the original material roll, and when the tension applied to the continuous sheet reaches or exceeds a predetermined value, slip the original material supporting shaft to make the tension applied to the continuous sheet constant.

CN201728891U discloses a system for preparing a positioning laser label comprising a machine base, a first discharging device and a first tension compensation device, wherein the first discharging device is positioned in front of the machine base and used for placing a printing material; the printing device group is arranged on the machine base, and a die cutting device is positioned behind the printing device group. The base is also provided with a laser imprinting device which is positioned in front of the printing device group; the first printing device of the printing device group is a metal reflective ink printing device; the system also comprises a second discharging device and a second tension compensation device, wherein the second discharging device is positioned in front of the machine base and used for mounting release materials.

EP1753670B1 relates to flexible packaging for products, and particularly discloses methods for making such packaging that is re-closable after initial opening comprising a flexible packaging laminate (46) formed by pattern-applying a pressure-sensitive adhesive (20) in a predetermined pattern (22) onto one surface of a first structure (10), and pattern-applying a permanent laminating adhesive (34) onto the one surface of the first structure (10) such that the permanent adhesive (34) does not cover the predetermined pattern (22) of pressure sensitive adhesive (20), and adhesively joining the first structure (10) to a second structure (42) via the permanent adhesive (34) so as to form the laminate. An opening and reclose feature formed in the laminate, and comprising an outer flap portion (86) formed by scoring through the outer structure (10) along an outer score line (52), and an inner flap portion formed by scoring through the inner structure (42) along an inner score line (62), the outer and inner score lines being spaced from all edges of the laminate (46), the inner score line (62) creating an opening into the container when the flap portions (86, 88) are peeled back, a marginal region (90) of the outer flap portion extending beyond an edge of the inner flap portion (88) and overlying an underlying surface of the inner structure (42), the flap portions (86, 88) being joined with the pattern-applied permanent adhesive (34), and the pattern-applied pressure-sensitive adhesive (20) being disposed between the marginal region (90) of the outer flap portion (86) and the underlying surface of the inner structure (42) for attaching and re-attaching the outer flap portion (86) to the underlying surface. The score lines (52, 62) are formed with a laser (54,64).

Other patent documents in the field related to labels and packaging with easy opening features are: US2022041358A1, WO2014142886A1, US2020071046A1, WO2015075420A1 and US2011198838A1, WO2011158014A1.

### DISCLOSURE OF THE INVENTION

The invention proposes a plant for laser scoring a web material as described in claim 1. Said plant is adapted to laser scoring and laminating the web material, or to laminating and later laser scoring the web material, or to only laser scoring the web material skipping the lamination thereof.
an unwinder station from which a web of flexible material, such as a polymeric film is fed to a support and guiding line by means of rollers;
a laser station included in a guided passage of the above-mentioned web of material, the laser station comprising at least one laser unit to create weakening lines by scoring the web with a certain contour in some target zones;
a labelling station included in another guided passage of the above-mentioned web of material, comprising at least a labelling unit, prepared for attaching by lamination a resealable label in these target zones; and
a slitter-rewinder station to rewind and or slit the web after treatment in the laser station and in the labelling station,
wherein the web of flexible material can be selectively driven to pass firstly through the laser station and then through the labelling station or the other way around, or to pass only through the laser station.

The present invention also proposes, optionally, to include in the passage of the web along said laser station a path through two adjustable web nips and a path in contact with an upper loadcell weighing device and in contact with a lower loadcell weighing device;

so that a dual controlled tension is applied to the web by acting on the adjustable web nips depending on the passage of the web first trough the laser station and then through the labelling station or the passage of the web first through the labelling station and then the web and label through the laser station; the dual tension being obtained by the different values of the loadcell weighing device, that are transmitted to a machine controller acting over the web nips.

The present invention also proposes a method as defined in claim 5.

The proposed method comprises:
feeding a web of flexible material, such as a polymeric film to a support and guiding line by means of rollers;
passing the fed web through a laser station comprising at least one laser unit to create weakening lines by scoring the web with a certain contour in some target zones;
passing the fed web with scored lines through a labelling station comprising at least a labelling unit, prepared for attaching by lamination a resealable label in these target zones; and
slit the fed web with label and rewind;
wherein the web of flexible material is selectively driven to pass firstly through the laser station and then through the labelling station or the other way around, or to pass only through the laser station.

### BRIEF DESCRIPTION OF THE FIGURES

The foregoing and other advantages and features will be more fully understood from the following detailed description of embodiments with reference to the accompanying drawings, to be taken in an illustrative and non-limitative manner, in which:

FIG. 1 is a layout of the plant embodiment including laser station + labelling station. Illustrating the unwinder station, the laser station and the labelling station. After the laser station and labelling station, a slitter station and rewinder station well known in the art has been included.

FIG. 2 is a layout of the plant embodiment including labelling station + laser station. Illustrating the unwinder station, the laser station and the labelling station. After the labelling station and laser station a slitter station and rewinder station well known in the art has been included.

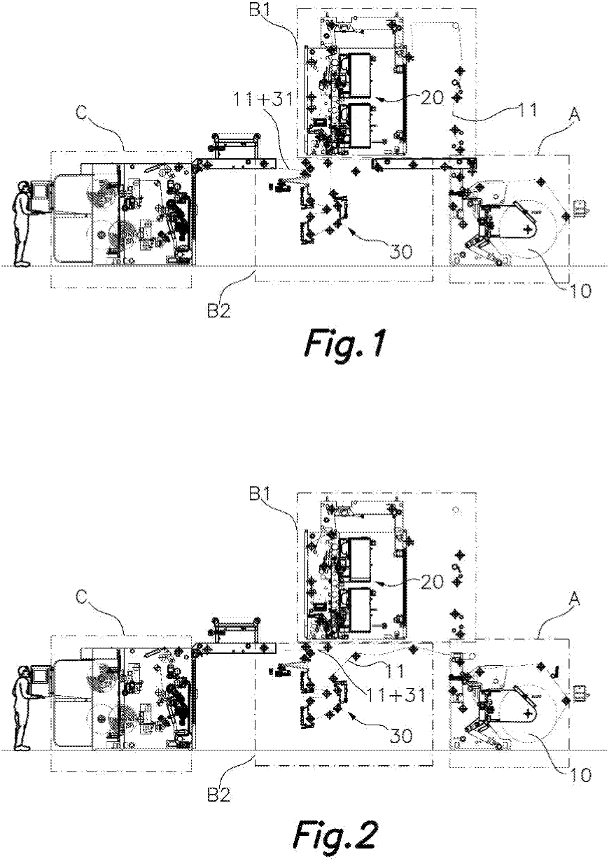

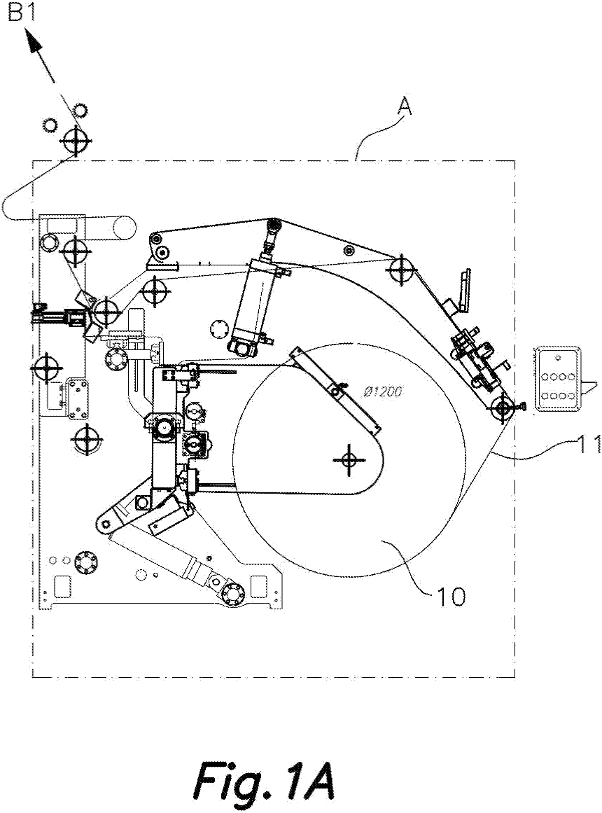

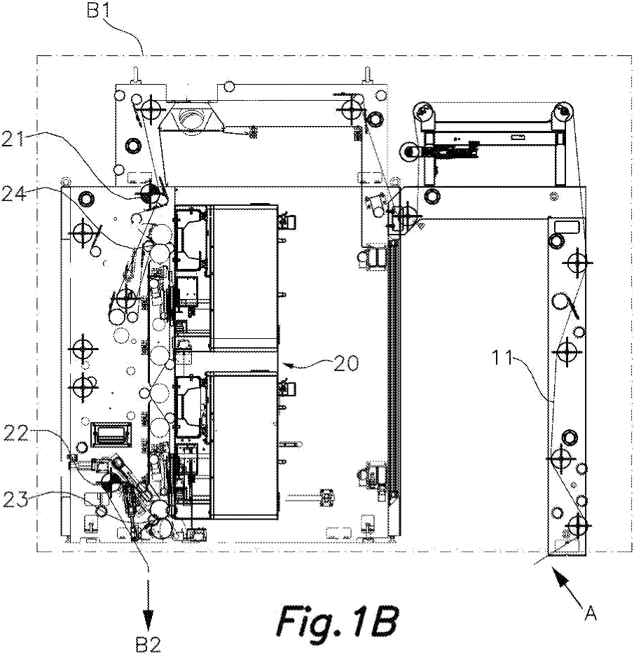

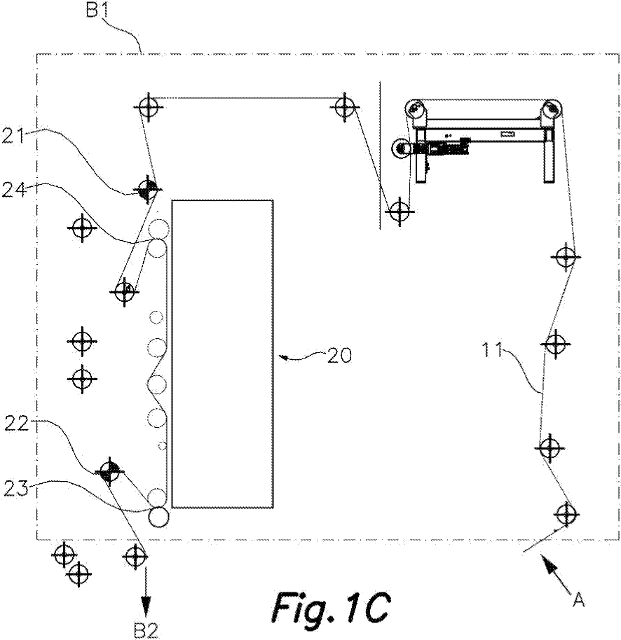

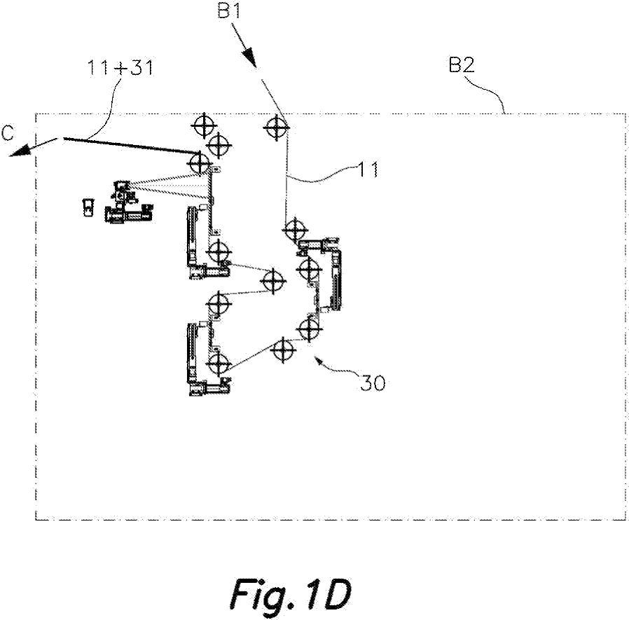

FIG. 1A is a detail of the embodiment of the unwinder station comprising the unwinder unit of web material feeding the laser station with web material.

FIGS. 1B and 1C is a detail of the embodiment of the laser station and the web material path with the dual tension control adjustment, upper web nip with the lower loadcell weighing device included in the laser unit.

FIG. 1D is a detail of the embodiment of the labelling station with the web material path through the labelling unit.

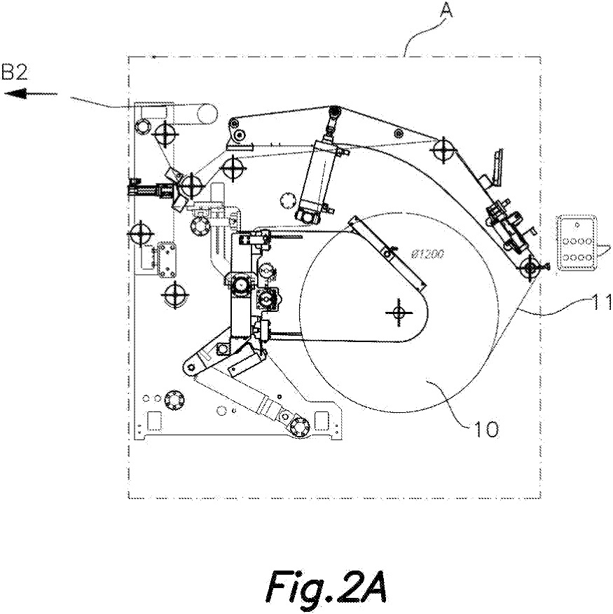

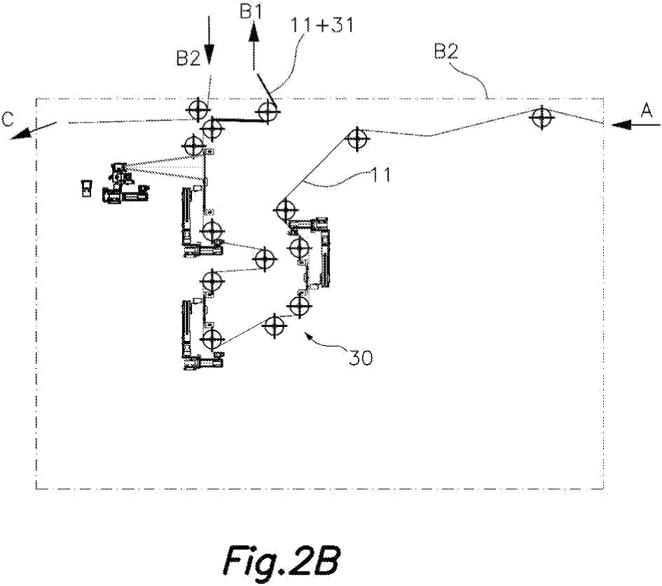

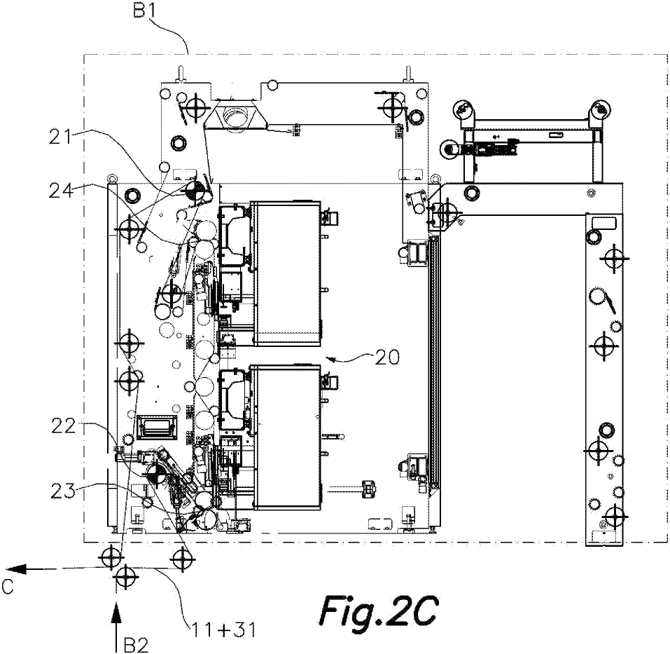

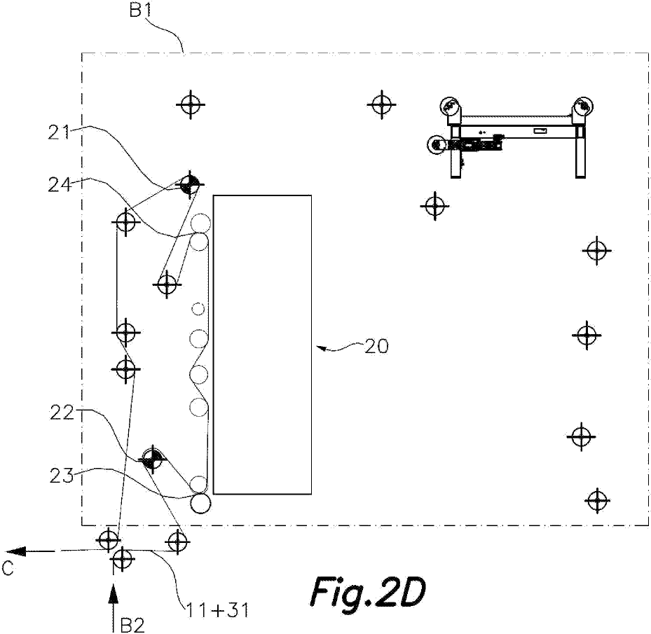

FIG. 2A is a detail of the embodiment of the unwinder station comprising the unwinder unit of web material feeding the labelling station with web material.

FIG. 2B is a detail of the embodiment of the labelling station with the web material path through the labelling unit feeding the web + label material to the laser station.

FIGS. 2C and 2D is a detail of the embodiment of the laser station and the web + label material path with the dual tension control adjustment, lower web nip with the upper loadcell weighing device included in the laser unit.

### DETAILED DESCRIPTION

As shown in the drawings the plant for laser scoring a web material. This invention comprises:
a plurality of rollers defining a guiding line which supports and conveys a web 11 of flexible material fed from an unwinder station A along a conveyance path towards a slitter-rewinder station C configured to rewind and/or slit the web 11;
a laser station B1 including a guided path portion through which a portion of the conveyance path can be routed, the laser station B1 comprising at least one laser unit 20 configured to create weakening lines on the web 11 with a certain contour by scoring the web 11 when passing though the guided path portion; and
a labelling station B2.

The proposed plant also includes the following features:
the labelling station B2 includes an additional guided path portion through which a portion of the conveyance path can be routed, the labelling station B2 including at least a labelling unit 30 configured to attach a resealable label 31 in the target zones of the web 11 when passing through the additional guided path portion;
the guiding line is adjustable to define the conveyance path as a first conveyance path passing firstly through the guided path portion of the laser station B1 and then through the additional guided path portion of the labelling station B2, or as a second conveyance path passing firstly through the additional path portion of the labelling station B2 and then through the guided path portion of the laser station B1, or as a third conveyance path passing only through the guided path portion of the laser station B1 skipping the labelling station B2.

The guiding line can be a manually adjusted, manually driving the web through the plant following the first, second or third conveyance path, or can be automatically adjusted changing the configuration of the guiding line to automatically drive the web through the first, second or third conveyance path.

When the guiding line is adjusted to define the first conveyance path, the web is first scored and later laminated with the label, but when the guide line is adjusted to define the second conveyance path, the web material passing through the laser station already includes the labels adhered thereto, so the laser scoring is produced on said labels now integrated as part of the web.

Optionally, the laser station B1 may include two web nips 23, 24, each defined between a pair of rollers of the guiding line which position is adjustable by roller actuators, and an upper loadcell weighing device 21 and a lower loadcell weighing device 22 in contact with portions of the conveyance path.

A machine controller can be configured to obtain values indicative of the web tension from the upper and lower loadcell weighing devices 21 and 22, and to determine a dual tension to be applied to the web 11 between the web nips 23, 24 considering said values and considering the adjustment applied to the guiding line defining the first, second or third conveyance path, because depending on the guiding line adjustments the laser scoring shall be effectuated on a web with or without a label adhered thereto and the dual tension shall be adapted correspondingly. Finally, the machine controller will be configured to actuate the roller actuators to apply said dual tension.

As can be seen in the drawings the passage of the web 11 along the laser station B1 includes a path through two adjustable web nips 23, 24 and a path in contact with an upper loadcell weighing device 21 and in contact with a lower loadcell weighing device 22.

Through these means and arrangements at least a dual controlled tension is applied to the web 11 by acting on the adjustable web nips 23, 24 depending on the passage of the web 11 first trough the laser station B1 and then through the labelling station B2 or the passage of the web 11 first through the labelling station B2 and then the web 11 including labels 31 through the laser station B1. The dual tension is obtained by the different values of the loadcell weighing device 21, 22, that are transmitted to a machine controller acting over the web nips 23, 24 adjusting the pressure on the web 11.

According to an embodiment of the present invention, the machine controller can be configured to determine laser scoring adjustment parameters to be applied by the at least one laser unit 20 considering the adjustment applied to the guiding line defining the first, second or third conveyance path. Said machine controller will be also configured to actuate the at least one laser unit 20 implementing said laser scoring adjustment parameters.

The web 11 may include a printing pattern, on the target zones, in which case the label 31 can be applied in exact correspondence with said printing pattern of the target zones.

Optionally, the labelling station B2 is configured to apply several labels 31 at different distances from a lateral edge of the web 11, wherein the slitter-rewinder station C is configured to slit the web in several parallel strips by cutting the web 11 at different distances from the lateral edge thereof, each strip including at least one label 31.

In other words, if the web contains different parallel lines of labels 31, which is the most common, the web is slitted in several parallel strips each including a line of labels 31.

As previously indicated a method for laser scoring a web material is also proposed, the method comprising: conveying a web 11 of flexible material following a conveyance path defined by rollers of a guiding line; creating weakened lines with a certain contour in target zones of the web 11 by scoring the web 11 with at least one laser unit 20 of a laser station B when the target zones of the web passes through a guided portion of the conveyance path included in the laser station B1; attaching a resealable label 31 in the target zones of the web 11 with at least one labelling unit 30 of a labelling station B2 when the target zone of the web passe through an additional guided path portion of the conveyance path included in the labelling station B2; and rewind and/or slit the web 11 by a slitter-rewinder station C.

The proposed method further comprises adjusting the guiding line to define the conveyance path as a first conveyance path passing firstly through the guided path portion of the laser station B1 and then through the additional guided path portion of the labelling station B2, or as a second conveyance path passing firstly through the additional path portion of the labelling station B2 and then through the guided path portion of the laser station B1, or as a third conveyance path passing only through the guided path portion of the laser station B1 skipping the labelling station B2.

The proposed method may further comprise obtaining values, indicative of the web tension, from an upper and a lower loadcell weighing devices 21 and 22 in contact with portions of the conveyance path when passing through the laser station B1, determining a dual tension to be applied to the web 11, between two web nips 23, 24, each defined on the laser station B1 between a pair of rollers of the guiding line which position is adjustable by roller actuators, considering said values and the adjustment applied to the guiding line defining the first, second or third conveyance path; and actuating the roller actuators to apply said dual tension.

The method can further comprise determining laser scoring adjustment parameters to be applied by the at least one laser unit 20 considering the adjustment applied to the guiding line defining the first, second or third conveyance path, and actuating the at least one laser unit 20 implementing said laser scoring adjustment parameters.

Optionally, the web 11 can include a printing pattern in exact correspondence with the target zones and the label 31 can be applied in exact correspondence with the target zones.

1. Plant for laser scoring, the plant comprising:
a plurality of rollers defining a auidina line which supports and conveys a web of flexible material fed from an unwinder station along a conveyance path towards a slitter-rewinder station configured to rewind and/or slit the web ;
a laser station including a guided path portion through which a portion of the conveyance path can be routed, the laser station comprising at least one laser unit configured to create weakening lines on the web with a certain contour by scoring the web when passing though the guided path portion; and
a labelling station including an additional guided path portion through which a portion of the conveyance path can be routed, the labelling station including at least a labelling unit configured to attach a resealable label in the target zones of the web when passing through the additional guided path portion;
the guiding line is adjustable to define the conveyance path as a first conveyance path passing firstly through the guided path portion of the laser station and then through the additional guided path portion of the labelling station, or as a second conveyance path passing firstly through the additional path portion of the labelling station and then through the guided path portion of the laser station, or as a third conveyance path passing only through the guided path portion of the laser station skipping the labelling station.

2. The plant according to claim 1 wherein the laser station includes two web nips, each defined between a pair of rollers of the guiding line which position is adjustable by roller actuators, and an upper loadcell weighing device and a lower loadcell weighing device in contact with portions of the conveyance path; and a machine controller configured to obtain values indicative of the web tension from the upper and lower loadcell weighing devices, configured to determine a dual tension to be applied to the web between the web nips in response to the values and depending on the adjustment applied to the guiding line defining the first, second or third conveyance path, and configured to actuate the roller actuators to apply the dual tension.

3. The plant according to claim 1 wherein the machine controller is configured to determine laser scoring adjustment parameters to be applied by the at least one laser unit considering the adjustment applied to the guiding line defining the first, second or third conveyance path, and configured to actuate the at least one laser unit implementing the laser scoring adjustment parameters.

4. The plant according to claim 1 wherein the web includes a printing pattern on the target zones, and the label is applied in exact correspondence with the printing pattern of the target zones.

5. The plant according to claim 1, wherein the labelling station is configured to apply several labels at different distances from a lateral edge of the web, wherein the slitter-rewinder station is configured to slit the web in several parallel strips by cutting the web at different distances from the lateral edge thereof, each strip including at least one label.

6. A method for laser scoring a web material, the method comprising:
adjusting a guiding line with rollers of a laser scoring plant to define a conveyance path as a first conveyance path passing firstly through a guided path portion of a laser station and then through an additional guided path portion of a labelling station, or as a second conveyance path passing firstly through the additional path portion of the labelling station and then through the guided path portion of the laser station, or as a third conveyance path passing only through the guided path portion of the laser station skipping the labelling station:
conveying a web of flexible material following the first, second or third conveyance path defined by the guiding line;
creating weakened lines with a certain contour in target zones of the web by scoring the web with at least one laser unit of the laser station when the target zones of the web passes through the guided portion of the conveyance path included in the laser station;
attaching a resealable label in the target zones of the web with at least one labelling unit of a labelling station if the target zone of the web passes through the additional guided path portion of the conveyance path included in the labelling station, when passing therethrough; and
rewinding and/or slitting the web by a slitter-rewinder station.

7. The method according to claim 6 wherein the method comprises:
obtaining values, indicative of the web tension, from an upper and a lower loadcell weighing devices in contact with portions of the conveyance path when passing through the laser station,
determining a dual tension to be applied to the web, between two web nips, each defined on the laser station between a pair of rollers of the guiding line which position is adjustable by roller actuators, considering the values and the adjustment applied to the guiding line defining the first, second or third conveyance path; and
actuating the roller actuators to apply the dual tension.

8. The method according to claim 6 wherein the method further comprises determining laser scoring adjustment parameters to be applied by the at least one laser unit considering the adjustment applied to the guiding line defining the first, second or third conveyance path, and actuating the at least one laser unit implementing the laser scoring adjustment parameters.

9. The method according to claim 6 wherein the web includes a printing pattern in exact correspondence with the target zones and the label is applied in exact correspondence with the target zones.
